(19) United States
(12) Patent Application Publication
(10) Pub. No.: US 2008/0183618 A1
(43) Pub. Date: Jul. 31, 2008

(54) Global government sanctions systems and methods

(75) Inventors: Michael R. Giacco, Hicksville, NY (US); Karen W. Schirmer, Centennial, CO (US); Lynn Eloisa Freyta, Lakewood, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/627,915

(22) Filed: Jan. 26, 2007

(51) Int. Cl. G06Q 40/00

(52) U.S. Cl. 705/40

(57) ABSTRACT

A suspect transaction dataset may be generated from screening a transaction dataset against a master suspect list. Often, this screening process results in a large percentage of false positives hits distributed among the data in the suspect transaction dataset. Among other things, embodiments of the invention provide systems and methods for removing the false positives from a suspect transaction dataset. Some embodiments of the invention use detailed decision matrices to generate, analyze, and cull the dataset. Other embodiments use multi-tiered screening with iterative feedback loops to perform those and other dataset functions.

### BACKGROUND OF THE INVENTION

Each day, financial institutions in the United States process millions of financial transactions, including stock purchases, credit and debit card transactions, cash transfers, loan authorizations, and debt collections. The vast majority of these dealings are a legitimate and necessary part of a capitalist economy. Some, however, are illegal, as they involve entities prohibited by the government from engaging in financial transactions.

The government agency responsible for these prohibitions is the Office of Foreign Assets Control, or OFAC. United States foreign policy, national security goals, and multinational arrangements often involve the implementation of sanctions, which limit trade and economic relations with individuals and with entire countries. OFAC has the authority to enforce these sanctions, in part by freezing foreign assets which are under US control. To help enforce sanctions, OFAC maintains lists of sanctioned countries as well as certain sanctioned individuals (Specially Designated Nationals, or SDN's). For example, the SDN list includes many international terrorists, drug and weapon traffickers, and other dangerous individuals.

Once sanctions have been imposed on an entity (e.g. an individual, organization, or country), it becomes illegal to either directly or indirectly engage that entity in a financial transaction. Therefore, institutions which engage in financial transactions must be careful to prevent those prohibited transactions from occurring. Even where the institution is acting only as a middleman in the transaction, it may be liable for violating sanctions, potentially subjecting the institution to civil and criminal penalties. In order to avoid potential liability for violating these sanctions, institutions must check all financial transactions against OFAC's lists to ensure that none of the transacting parties fall within a government-imposed sanction.

Unfortunately, checking transactions against OFAC's lists can be tricky. Say a restaurant is serving a packed house for dinner. One of their customers is a Benjamin Laden. When Mr. Laden attempts to pay with his credit card, the transaction is checked against OFAC's lists by the restaurant's bank. The bank detects a close match between Mr. Laden's name and the name of infamous international terrorist, Osama Bin Laden. To prevent violation of a sanction and ensure OFAC compliance, the bank must reject the transaction. Further, because the restaurant is now suspect for possibly transacting with a known international terrorist, the bank may revoke the restaurant's ability to take credit cards until the issue is resolved. The restaurant is now left with a room full of diners who will only be able to pay for their dinner if they have cash.

Clearly, it would be uncommon for a person or business to have the exact same name as a sanctioned entity (or if it was a sanctioned entity, it is unlikely it would use its exact real name. Therefore, it may be necessary to find inexact matches. However, detecting inexact matches also creates the potential for many types of matches when no threat exists (or “false positives”).

To illustrate this, imagine that a company called Jonathan Cubanis Enterprises, Ltd. applies for a business loan with First Bank. First Bank checks the business name and information against OFAC's lists. Because Cuba us a sanctioned country, and “Cuba” appears within the word “Cubanis,” the system may detect a match (or a “hit”).

It is easy to imagine thousands of similar cases where a match would be detected incorrectly. Words which happen to be identical or similar to sanctioned entities may show up in people's names, business' names, street names, etc. The result is that any attempt to check a set of transactions against OFAC's lists will likely yield a large set of hits, most of which will be false positives.

Without further analysis, banks and other institutions would have to deny many non-sanctioned entities the ability to engage in financial transactions. Thus, the removal of false positives is very important to simultaneously ensuring compliance and maintaining a successful economy. Various approaches have been explored for dealing with the accurate and efficient removal of false positives.

A first approach is to follow up on all hits. Following up on every hit ensures compliance and makes the detection of sanctioned transactions much more likely, but it is also very costly and inefficient. Similarly, an organization may employ a second approach—following up on none of the hits. Following up on no hits saves lots of time and money and removes the risk of incidentally shutting down lawful transactions, but it also ensures non-compliance and institutional liability. Clearly, the ideal approach falls somewhere in the middle.

A third approach is to adjust the sensitivity of the matching algorithm. In general, hits are detected by checking a list of transactions against a suspect database containing OFAC's lists. The checking is performed by a computer, which analyzes each transaction record to see if any part matches any entry in the database. The computer may be set to find a match with varying degrees of sensitivity to elements, such as spelling, spaces, abbreviations, etc.

The benefit of this approach is that using a lower-sensitivity system will likely remove many of the false-positive hits. However, lowering the sensitivity may also cause the system to ignore real hits, allowing transactions to clear which involve sanctioned entities. It is unlikely that a terrorist will use his full, real name on a credit card application. Therefore, the detection of exact matches would probably not catch the vast majority of sanctioned transactions, and the government may determine that low-sensitivity systems do not fully comply with the OFAC regulations.

For the above reasons, a fourth approach may be desirable, which would offer consumers a more accurate and efficient method for removing false-positive hits.

### BRIEF SUMMARY OF THE INVENTION

Embodiments of the invention can address this condition in the art by providing methods and systems for removing false-positive hits, including multi-tiered screening methods and systems with detailed decision trees and feedback mechanisms.

A first set of embodiments provides a method for screening transaction data against a master suspect list and removing false positives. The method uses a computer to generate a suspect transaction dataset. The suspect transaction dataset comprises a suspect record, which in turn comprises a set of data, a stop designator, and a master datum type code. At least one of the set of data is a common datum which is substantially identical to a master suspect list datum. Both the common datum and the master suspect list datum are of a datum type. The stop designator represents the common datum, and the master datum type code designates the datum type of the master suspect list datum.

The method then provides the suspect transaction dataset to a reviewer, along with a set of decision codes. The set of decision codes comprises a quick decision code. Then, the reviewer is prompted to select a selected decision code from the set of decision codes to associate with the suspect record. This selection is based at least in part on the stop designator and the master datum type code.

The selected decision code is associated with the suspect record, and the reviewer is prompted for further information relating to the removal of false positives. This further information is also associated with the suspect record.

In some embodiments, the reviewer is only prompted for further information if the selected decision code is not the quick decision code. Also, in some embodiments, when the selected decision code is the quick decision code, the suspect record is removed from the suspect transaction dataset.

In other embodiments, the suspect record is then communicated to a quality controller to check whether the reviewer selected an appropriate decision code to associate with the suspect record. The method then receives a quality determination from the quality controller. In some of these embodiments, the reviewer is a first reviewer, and when the quality determination reflects that the reviewer selected an inappropriate decision code to associate with the suspect record, the suspect record is provided to a second reviewer. In some cases, the second reviewer is the first reviewer.

In others of these embodiments, the suspect record is marked to reflect the quality determination. In still others of these embodiments, the suspect transaction dataset is stored in a queue, and the queue allows for prioritization based at least on the quality determination.

In still other embodiments, the method further comprises communicating the suspect record to a next higher authority, providing the next higher authority with a first research tool; and receiving, from the next higher authority, a disposition. The disposition is based at least in part on data from the first research tool and reflects either a block condition, a clear condition, or a hold condition.

In some of these embodiments, the next higher authority is a first next higher authority and the disposition is a first disposition. In these embodiments, the method further comprises communicating the suspect record to a second next higher authority when the first disposition reflects a hold condition, providing the next higher authority with a second research tool, and receiving, from the second next higher authority, a second disposition. The second disposition is based at least in part on data from the second research tool and reflects either a block condition, a clear condition, or a hold condition. In others of these embodiments, the method further comprises prompting the next higher authority for more information relating to the disposition. And in others of these embodiments, the method further comprises marking the suspect record to reflect the disposition.

In yet other embodiments, the quick decision code is the selected decision code whenever the datum type designated by the master datum type code is different from datum type of the common datum. In yet other embodiments, the reviewer is provided with a set of quick decision data. In these embodiments, the quick decision code is the selected decision code whenever the datum type designated by the master datum type code is substantially equivalent to the datum type of the common datum, and the common datum is substantially equivalent to one of the set of quick decision data.

In still other embodiments, each of the datum types is an element of a data type set comprising geographic location, individual name, and business name.

A second set of embodiments provides a system for screening transaction data against a master suspect list and removing false positives. The system comprises a data store and a control processor. The data store is configured to store a suspect transaction dataset comprising a suspect record.

The suspect record comprises a set of data, at least one of the set of data being a common datum which is substantially identical to a master suspect list datum, both the common datum and the master suspect list datum being of a datum type. The suspect record further comprises a stop designator representing the common datum and a master datum type code designating the datum type of the master suspect list datum.

The control processor is interfaced with the data store and associated with a computer readable medium. The computer readable medium comprises instructions executable by the control processor to provide, to a reviewer, a set of decision codes comprising a quick decision code; prompt the reviewer to select a selected decision code from the set of decision codes to associate with the suspect record, the selection being based at least in part on the stop designator and the master datum type code; associate the selected decision code with the suspect record; and prompt the reviewer for further information relating to the removal of false positives and associating the further information with the suspect record.

In some embodiments, the instruction to prompt the reviewer for further information occurs only when the selected decision code is not the quick decision code.

A third set of embodiments provides a method for screening a transaction dataset against a master suspect list and removing false positives. The method screens the transaction dataset against the suspect list using a first computer. The first computer comprises a first screener and a first set of screening criteria. This first screen generates a suspect transaction dataset, which comprises a set of suspect data. At least a portion of the set of suspect data are false positives.

The method then screens each suspect datum in at least a portion of the suspect transaction dataset using a second screener and a second set of screening criteria. A set of second screen results are generated, each representing either a clean or a suspect condition of a respective screened suspect datum.

The method then screens at least a portion of the set of second screen results to remove at least a portion of the set of false positives using a third screener and a third set of screening criteria. A third screen result is generated. Using a second computer, the first set of screening criteria are updated based at least in part on the third screen result.

In some embodiments, screening at least a portion of the second screen result further comprises: evaluating for quality at least a portion of the set of second screen results for which the second screen result represents a clean condition; generating an evaluation result reflecting either an accurate second screen result or an inaccurate second screen result; and sending at least a portion of the set of second screen results to a fourth screener when the evaluation result reflects an inaccurate second screen result. In some of these embodiments, the third screener is one of a group of reviewers and the fourth screener is the same one of the group of reviewers.

In other embodiments, screening at least a portion of the second screen result further comprises: providing the third screener with a research tool; evaluating, using the research tool, each of the set of second screen results for which the second screen result represents a suspect condition; generating an evaluation result from the evaluating step, reflecting either a determination condition or a no determination condition; and sending at least a portion of the set of second screen results to a fourth screener when the evaluation result reflects a no determination condition. In some of these embodiments, the third screener is one of a hierarchy of reviewers and the fourth screener is another of the hierarchy of reviewers.

In yet other embodiments, the method updates at least one of the suspect transaction dataset or the suspect list based at least in part on the third screen result. And in other embodiments, the second computer is the first computer.

In still other embodiments, the method sends, to a report generator, screen result data reflecting at least the third screen result. In some of these embodiments, a report is generated based at least in part on the screen result data.

A fourth set of embodiments provides a system for screening a transaction dataset against a master suspect list and removing false positives. The system comprises a first screening system, a second screening system, and a third screening system. The first screening system comprises a first screener, a first set of screening criteria, and a first data store. The first screening system is configured to generate a suspect transaction dataset by screening the transaction dataset against the suspect list using the first screener and the first set of screening criteria; and to store the suspect transaction dataset to the first data store.

The second screening system is communicatively coupled with the first screening system, and comprises a second screener, a second set of screening criteria, and a second data store. The second screening system is configured to: screen at least a portion of the suspect transaction dataset using the second screener and the second set of screening criteria; generate a second screen result; and store the second screen result to the second data store.

The third screening system is communicatively coupled with the second screening system and comprises a third screener and a third set of screening criteria. The third screening system is configured to: screen at least a portion of the second screen result using the third screener and the third set of screening criteria; generate a third screen result; and update the first set of screening criteria based at least in part on the third screen result.

Some embodiments further comprise a report generator configured to generate a report based at least in part on screen result data. The screen result data reflects at least the third screen result. In other embodiments, at least one of the first screening system, the second screening system, or the third screening system comprises a person.

This summary provides only a general outline of embodiments according to the present invention. Many other objects, features and advantages of the present invention will become more fully apparent from the following detailed description, the appended claims and the accompanying drawings.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1A provides a flow diagram summarizing multi-tiered methods of removing false positives from a suspect transaction dataset according to various embodiments of the invention.

FIG. 1B provides a data flow diagram summarizing an exemplary flow of data through a multi-tiered method of removing false positives from a suspect transaction dataset according to various embodiments of the invention.

FIGS. 2A-2D provide a flow diagram of an exemplary method of removing false positives from a suspect transaction dataset according to an embodiment of the invention.

FIG. 3 provides a system block diagram illustrating systems for executing multi-tiered methods of removing false positives from a suspect transaction dataset according to various embodiments of the invention.

FIG. 4 provides an illustrative block diagram illustrating a system for removing false positives from a suspect transaction dataset according to various embodiments of the invention.

FIG. 5 provides a flow diagram summarizing methods of removing false positives from a suspect transaction dataset according to various embodiments of the invention.

FIG. 6A provides a flow diagram summarizing additional methods of using quality control to help remove false positives from a suspect transaction dataset according to various embodiments of the invention.

FIG. 6B provides a flow diagram summarizing additional methods of using next levels of authority to help remove false positives from a suspect transaction dataset according to various embodiments of the invention.

FIGS. 7A and 7B provide exemplary decision trees which may be used by reviewers when screening suspect files according to various embodiments of the invention.

FIG. 8 provides an exemplary reviewer interface screen with which a reviewer may screen suspect files according to various embodiments of the invention.

FIGS. 9A and 9B provide exemplary flow diagrams summarizing methods of using quick decision codes to block or clear hits in a suspect transaction dataset according to various embodiments of the invention.

FIG. 10 provides a system diagram illustrating exemplary relational data records which may be used with various embodiments of the invention.

FIG. 11 provides a system block diagram illustrating systems for single- or multi-tiered removal of false positives from a suspect transaction dataset according to various embodiments of the invention.

### DETAILED DESCRIPTION OF THE INVENTION

Among other things, embodiments of the invention provide systems and methods for removing false positives from a suspect transaction dataset. Some embodiments may use multi-tiered screening with iterative feedback loops to perform those and other functions. Other embodiments may use detailed decision matrices to generate, analyze, and cull the dataset.

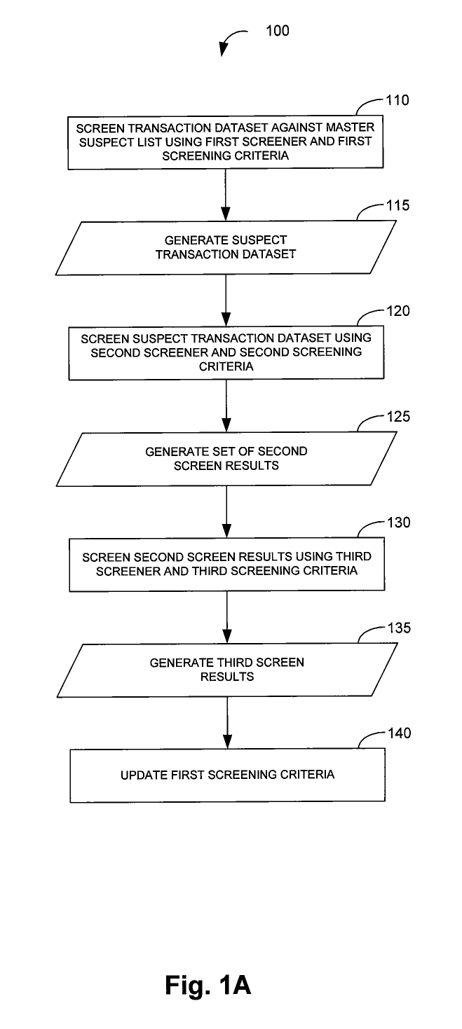

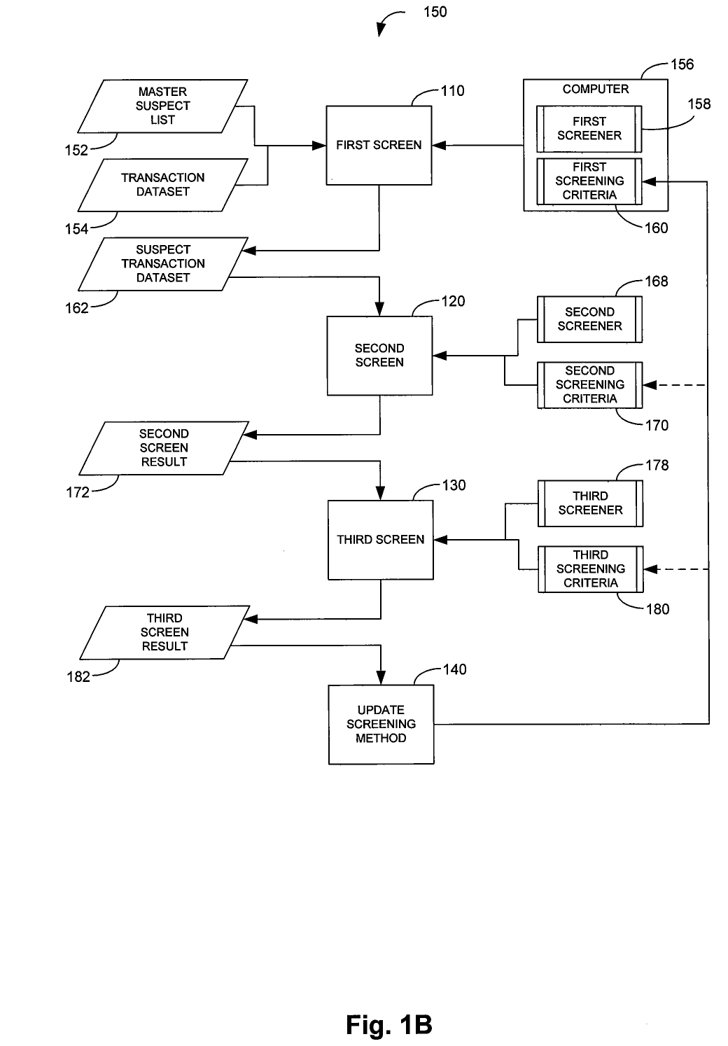

FIG. 1A provides a flow diagram of multi-tiered methods for removing false positives from a suspect transaction dataset according to various embodiments of the invention. The method 100 may screen 110 a transaction dataset against a master suspect list using a first screener and a first set of screening criteria to generate 115 a suspect transaction dataset. The method 100 may then screen 120 the suspect transaction dataset using a second screener and a second set of screening criteria to generate 125 a set of second screen results. The set of second screen results is then screened 130 using a third screener and a third set of screening criteria to generate 135 a set of third screen results. Finally, the first set of screening criteria are updated 140 based at least in part on the third screen results.

FIG. 1B provides a data flow diagram of some of the embodiments summarized by FIG. 1A. A Master Suspect List (MSL) 152 and a Transaction Dataset (TDS) 154 are provided to the first screen data process 110. The MSL 152 may be any list of suspect data, including, but not limited to the OFAC lists. The TDS 154 may contain data relating to the transactions to be screened. For example, the TDS 154 may be all credit card transactions passing through a particular bank. Data may stream through the TDS 154, the TDS 154 acting more as a buffer or queue. Alternatively, the data may represent a set of stored transactions, or even a subset of transactions based on particular criteria.

Either the MSL 152 and the TDS 154 may be stored and/or maintained internally or externally, and may be updated periodically or in real time. Further, either list may be a local mirror of an externally-stored database. Data in the MSL 152 or TDS 154 may be stored in a flat file, a relational database, or any other effective data storage format. This data may also be sorted or prioritized, if desired. If this data is stored relationally, it may be associated with a datum type, a priority code, and/or any other useful attribute.

Additionally, each dataset (or both datasets) may exist within a system which provides additional or separate security. These security systems may allow for particular data privacy and security guarantees. For example, the Specially Designated Nationals list is controlled by OFAC due to the particular associated national security concerns. If the MSL 152 is a mirror of all or part of this list, the same or different security protocols may be desired or required to protect that mirror.

The MSL 152 and TDS 154 are passed to the first screen step 110 to be analyzed. Generally, this first screen step 110 is processed by a computer 156. It will be appreciated that the processing could similarly be accomplished in other ways, including manually, or by some dedicated hardware or software. The computer 156 uses a first screener 158 and a set of first screening criteria 160 to screen the TDS 154 against the MSL 152. This first screen step 110 generates a Suspect Transaction Dataset (STDS) 162, containing at least the set of matches, or “hits,” between the two lists. The set of hits may represent the set of potentially suspect transactions.

For example, the first screener 158 and the set of first screening criteria 160 could be generated by the Accuity system, a Java-based software system configured in part to screen transactions against the OFAC lists. Each time a datum from the TDS 154 (e.g. a set of credit card transactions waiting to clear through a bank) matches a datum from the MSL 152 (the OFAC lists, in this example), a hit may be generated in the STDS 162. Each hit would represent that part of a transaction matches some part of a suspect entity on an OFAC list.

It will be appreciated that first screener 158 and the set of first screening criteria 160 may be configured in many different ways, which may impact the generation of the STDS 162. For example, the set of first screening criteria 160 could be adjusted to consider different variables when determining whether or not a hit should be detected or recorded. This may effectively change the sensitivity of the matching algorithm. The sensitivity may be related to any number of factors, including syntax (word order, spaces, hyphens, etc.), abbreviations (for address listings, organization names, people's names, etc.), or aliases (for organization names, people's names, etc.).

Many examples highlight the fact that neither a high-sensitivity nor a low-sensitivity system will provide the ideal balance between correctly detecting bad transactions and correctly avoiding detection of good transactions. A low-sensitivity system will likely fail to detect many transactions which should be blocked, while a high-sensitivity system will likely try to block many transactions which are actually clean (e.g. not suspect, sanctioned, illicit, etc.). These incorrect hits coming from high-sensitivity systems are often called “false positives.”

In one example, say the first screener 158 is screening a TDS 154 against a MSL 152 containing the name “Osama Bin Laden,” an international terrorist on an OFAC list. If the set of first screening criteria 160 are set to effectuate a low-sensitivity system, hits may only be generated and recorded to the STDS 162 if a datum in the TDS 154 matches the full text string, “Osama Bin Laden.” A high-sensitivity system, on the other hand, may find and record a hit if a TDS 154 datum contains anything similar, like “Osama B. Laden,” “O. B. Laden,” “Laden Enterprises,” or even “Bill Aden.”

This example illustrates two difficulties with using simple matching algorithms: that suspect entities are unlikely to use their exact names in transactions; and that suspect data often appears in modified forms. In another example, say OFAC lists show Cuba as a sanctioned country to which travel from the United States is not allowed. A company specializing in booking travel to Cuba may have a name like “Cuban Travel,” “TravelCuba.Com,” or “Cubamerica, Ltd.” While these company names all relate to Cuba, none contains the stand-alone term, “Cuba.”

On the other hand, a company using a high-sensitivity system will detect and report many businesses either which have nothing to do with Cuba, or which participate only in legitimate Cuba-related business. For example, the system may detect businesses and organizations with names like “The Cuban-American Student Association,” “Jonathan Cuban Enterprises,” or the “Chamber of Commerce of Cuba, Mo.”

It will be appreciated that in many cases, it is desirable to err on the high-sensitivity side. This is because a company which uses a low-sensitivity system will potentially participate in many undesired transactions, and may subject itself to many different types of liability to partners, customers, or even the government. Thus, it may be most effective to adjust the set of first screening criteria 160 to be highly sensitive, while still eliminating those hits for which its falsity is relatively or absolutely certain.

Adjusting the set of first screening criteria 160 in this way will likely produce a high percentage of false positives, depending on the types of data in the MSL 152 and TDS 154. Say, for instance, that the TDS 154 contains all credit card transactions passing through a typical American bank, and the MSL 152 contains OFAC list data. It is unlikely that government-sanctioned entities will do business through those channels in a way which is traceable to a particular datum on the OFAC lists. However, many business names, country names, personal names, and other data will be similar to sanctioned data on the OFAC lists. Therefore, a first screen step 110 under these conditions will probably produce a large STDS 162 (a large quantity of hits), but the vast majority of hits will be false positives. Removing those false positives from the STDS 162 requires further processing.

The STDS 162 may then be passed to a second screen step 120 for further processing. In this second screen step 120, a second screener 168 uses a set of second screening criteria 170 to generate a second screen result 172. This second screener 168 may be an automated or manual process, and it may be performed by hardware, software, human interface, or any other effective means. For example, the second screener 168 may be a human user with access to a workstation and a set of decision criteria which make up the set of second screening criteria 170.

It will be appreciated that the second screener 168 may be one of many second screeners, each with access to a shared or separate set of second screening criteria 170. In a distributed environment with multiple second screeners, each second screener 168 may have access to only part of the STDS 162.

This part of the STDS 162 may be allocated manually or automatically. The allocation may be based on various algorithms, including load-balanced, random, priority, authority, or any other useful allocation. Further, the allocation may occur in real time as the records enter the second screen step 120, in batches as sets of records enter the second screen step 120, or at certain other intervals. According to certain algorithms, the records may also be re-allocated continually or periodically. Allocation algorithms may also use one or more feedback mechanisms to improve record allocation over time.

The second screener 168 may then review records. Records may be reviewed individually or in groupings based at least in part on the set of second screening criteria 170. This review generates a set of third screen results 182. This set of third screen results 182 may represent an initial determination of whether the reviewed records are legitimate hits or false positives.

Based on various factors (e.g. the authority of the second screener 168), the second screener 168 may be restricted in what determinations are allowed. For example, the second screener 168 may be given authority to block or clear a record if the second screener 168 is relatively certain of the appropriate determination. It will be appreciated that relative certainty may be defined subjectively based on the experience and knowledge of the second screener 168, objectively based on algorithms or criteria, or in some other way. In cases like this, the second screener 168 may be required to pass the record on to a third screener whenever uncertain (or at least not relatively certain) of the appropriate determination.

In a different example, the second screener 168 may be required to mark each record with an initial determination. The record and its marking could then be sent to a third screener for further review.

In any case, the second screen results 172 may then be sent to the third screen step 130. The third screen step 130 uses a third screener 178 and a set of third screening criteria 180 to generate a set of third screen results 182.

The data received at the third screen step 130 may consist of the entire set of second screen results 172, a subset of the set of second screen results 172, or any other relevant set of data based at least in part on the set of second screen results 172. This data may be prioritized and/or allocated, if desired.

Further, it will be appreciated that various types of third screening steps 130 are possible. A first type of third screening step 130 may be a similar or identical step to the second screen step 120, used for further review. A second type of third screening step 130 may involve third screeners 178 with higher or different authority. For example, while the second screener 168 may only have the authority to suggest blocking a record, the third screener 178 may have the authority to actually block a record. A third type of third screening step 130 may involve third screeners 178 with access to more or different information, including access to certain research tools or databases. For example, while the second screener 168 may have access only to certain public databases, the third screener 178 may have access to certain restricted databases. A fourth type of third screening step 130 may involve third screeners 178 from other agencies or departments. For example, while the second screener 168 may be from an internal review department, the third screener 178 may be from a government or third-party agency. A fifth type of third screening step 130 may involve third screeners 178 with quality control, auditing, or other types of qualifications. For example, while the second screener 168 may be looking at large volumes of data for suspect records, the third screener 178 may look at small subsets for quality control or auditing purposes.

It will be appreciated that any or all of the third screener 178, the set of third screening criteria 180, and the set of third screen results 182 may be adjusted to fit the type of third screen step 130 chosen. Further, it will be appreciated that multiple third screen steps 130 of different types may be used in parallel, series, or both to accomplish certain useful results. The configuration and use of these different third screen steps 130 may also be dictated manually or automatically, for example, by algorithm, situation, organizational need or convenience, or feedback. Additionally, the same or different third screen steps 130 may occur iteratively (thereby being either part of the same third screen step 130 or becoming a fourth, fifth, etc. screen step).

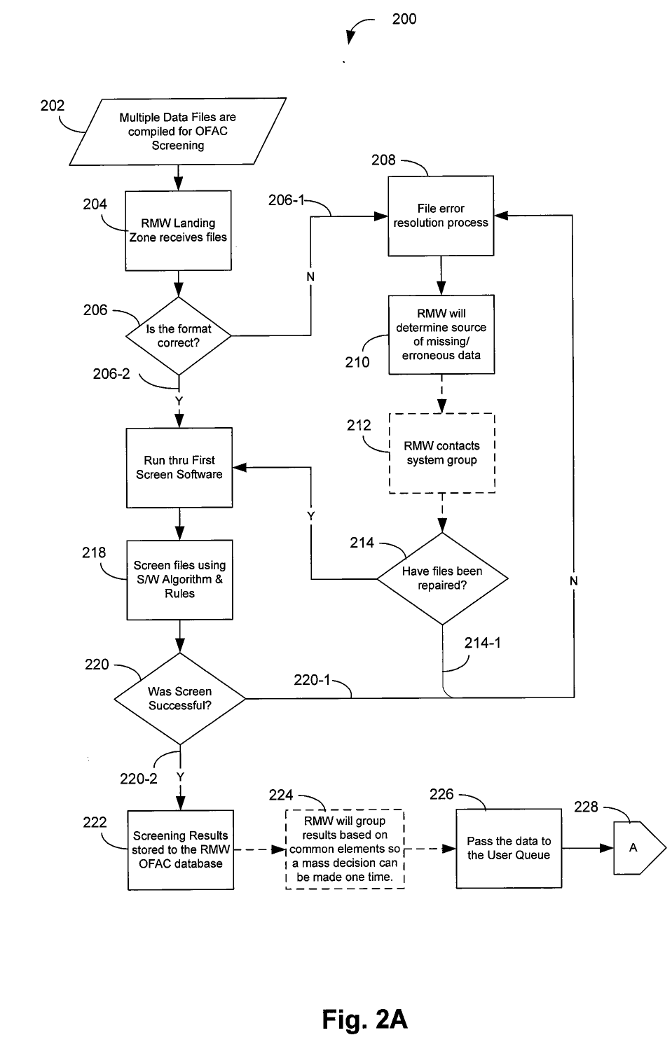

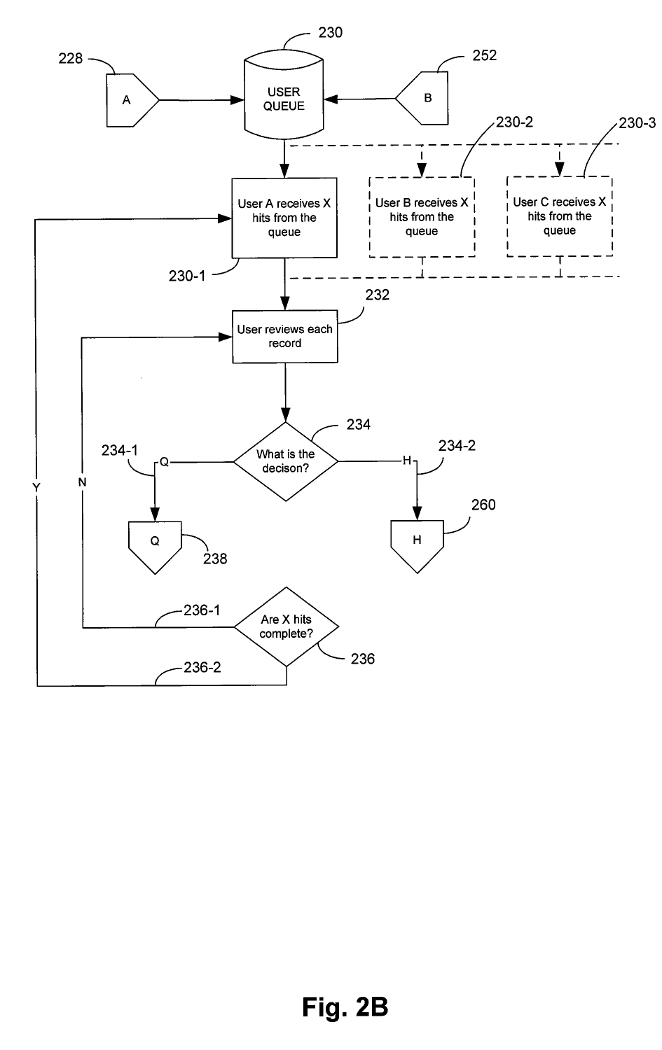

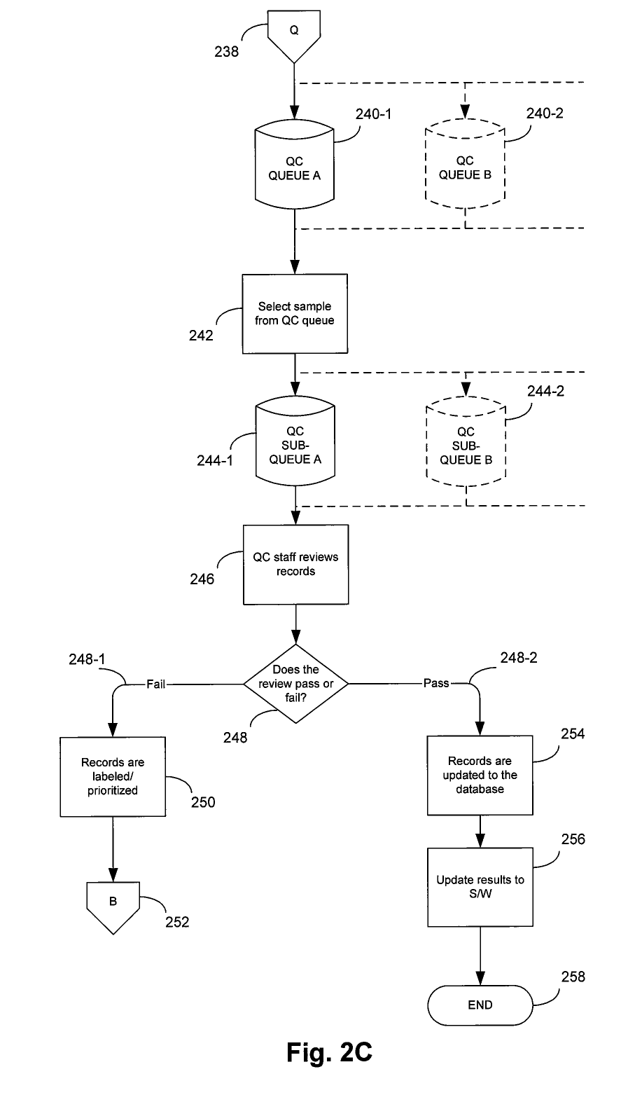

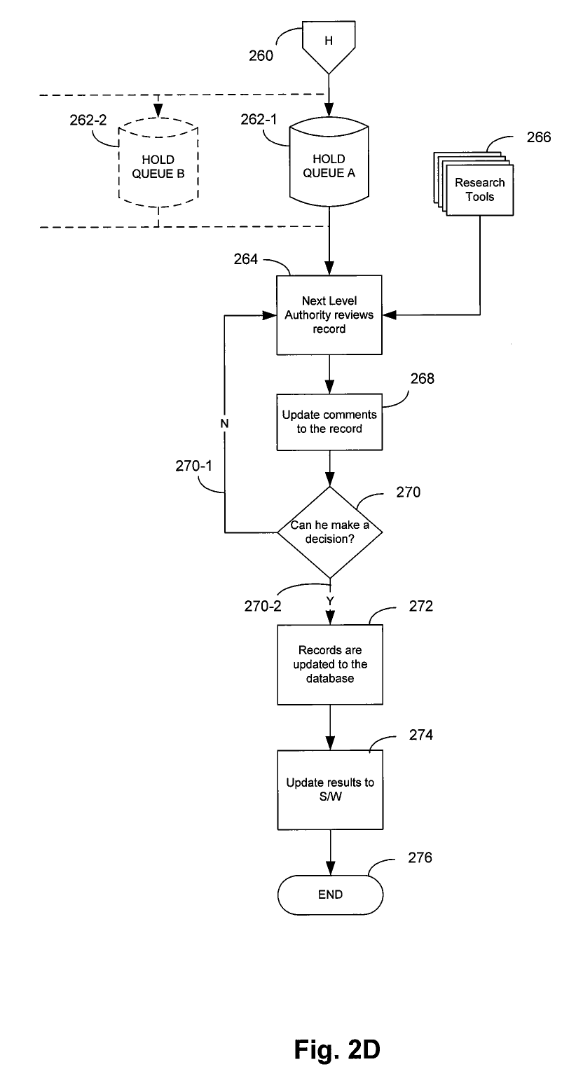

In one exemplary embodiment, two third screen steps 130 are employed; the first using third screeners 178 with different authority profiles, and the second using third screeners 178 with quality control functions. These two third screen steps 130 act in parallel on different subsets of the set of second screen results 172. Those records marked by the second screener 168 as being suspect are sent to the first of the third screen steps 130, while records marked by the second screener 168 as being clean are sent to the second of the third screen steps 130. A similar embodiment is discussed below in relation to FIGS. 2-6.

The third screen step 130 results in a set of third screen results 182. This set of third screen results 182 may represent a final disposition of the records of data. Based at least in part on this set of third screen results 182, the screening method may be updated 140. This updating step 140 may in turn update at least the set of first screening criteria 160. Updating the set of first screening criteria 160 may act as a feedback loop to help improve the efficacy of the first screen step 110 over time.

FIGS. 2A-2D provide flow diagrams of an exemplary method for removing false positives from a suspect transaction dataset according to embodiments of the invention. The method is illustrated, and will be discussed, in relation specifically to screening false positive hits from a multi-tiered OFAC screening process. It will be appreciated, however, that the features and configurations of this embodiment may prove useful in other embodiments of the invention, including other types of screening against other types of databases, and for other uses.

The method 200 begins in FIG. 2A when multiple data files are compiled 202 for OFAC screening. These data files may represent data from certain financial transactions. For example, the data may represent all credit card transactions in which at least one party to the transaction seeks to draw funds for the transaction from a particular financial institution. In another example, the transactions may be compiled 202 based on certain types of criteria. For instance, it may be determined that most suspect transactions with Cuba tend to occur during normal Cuba business hours. Certain types of screening may then be performed on transactions with time stamps during those hours.

It will be appreciated that the method 200 may be executed on one or more files continually, periodically, on an ad hoc basis, or in any other useful way. Further, files may be selected at random, specifically based on certain criteria, or by some other process.

The compiled data files may then be sent to a government sanctions system (GSS), and the GSS receives 204 the files at a landing zone. For example, the GSS may be a computer or server located virtually at a landing zone designated on the network as an Internet Protocol (IP) address. It will be appreciated that the function of the GSS may be accomplished using many useful system configurations, including series or parallel processing, single or multiple computers, mirror IP addresses, virtual connections and workstations, and others.

After the GSS receives 204 the files, a decision point 206 occurs. At this decision point 206, the GSS reviews characteristics of the files. For example, the GSS may check to make sure the files are saved in the proper format, that the necessary data is present, that certain header information is available, etc. Additionally or alternately, the decision point 206 may act on the set of files to determine whether file types are consistent, whether files are missing, whether common characteristics are present, etc. This decision point 206 may be executed manually or automatically.

If the format is incorrect 206-1, a file error resolution process 208 is entered. As part of this file error resolution process 208, the GSS will attempt to determine the root cause of the erroneous or missing data. For example, the GSS may communicate with other databases, nodes on the system, etc. to find missing files. In another example, the GSS may seek to add header information, convert file types, or perform other functions to correct file errors.

If the source of error cannot be determined, the GSS may contact 212 the system group or some other entity which may have other information, authority, etc. For example, the GSS may contact 212 the information technology group to alert them of files entering the system in incorrect formats, or the GSS may contact 212 the records department to alert them to apparently-missing records. It will be appreciated that the GSS may have to be configured to communicate with multiple systems to be able to resolve these types of issues.

At this point another decision point 214 is entered to determine whether the files have been appropriately repaired (e.g. have files of the wrong format been converted or have missing files been located). If the files have not been repaired 214-1, the method may perform a different file error resolution process, execute another iteration of the same file error resolution process 208, halt and output an error, or provide some other result. If the files have been repaired 214-2, the file error resolution process 208 is complete for that set of files.

The process continues at this point if either the files were repaired 214-2 or the files were in the correct format at the first decision point 206. The file set may be run 216 through first screen software. In some embodiments, this software may be the Accuity Java FACfilter software. Using this first screen software, the files may be screened 218 using certain algorithms or rules. For example, the Accuity software contains algorithms for screening transaction data against the OFAC lists. The files may be screened 218 in series or in parallel, in one or more virtual or physical location. Further, the files may be screened 218 as they arrive, in batches, or in any other useful way.

After the files are screened 218, a third decision point 220 is reached to check whether the first screen was successful. This decision point 220 may re-examine the files for the same errors or omissions as in the first decision point 206. Alternately or additionally, the decision point 220 may error check the screening software results, look for files which may have disappeared, or perform any other useful function on the screened data. If the screen is unsuccessful 220-1, another iteration of the file error resolution process 208 may be performed. It will be appreciated that other types of decision point 220 functions may require other types of resolution.

If the first screen is successful 220-2, the results may be stored 222 to a database. This database may be an OFAC database which is part of the GSS system. Many different types of data storage are possible for storing this data, including single or multiple servers, or distributed or relational databases. Further, it may be desirable for the data to be protected physically (e.g. by locating the server in a locked room) or virtually (e.g. by encrypting files or by requiring passwords for access). Even further, the database may be collocated or separate from the GSS system.

Once the files are stored, or at some other time, it may be useful to group 224 the screen results. This grouping may provide many useful results, including improving future viewing or auditing of the data, or allowing mass decisions to be made on multiple files which share common characteristics.

The screened data may then be passed 226 to the user queue for a second tier of review, marked by connector 228.

In FIG. 2B, the method continues at connector 228 when data coming from the first tier of review passes to the main user queue 230. The passing of data may be accomplished by pushing the data to the main user queue 230, pulling the data from the main user queue 230, or any other appropriate method. It will be appreciated that the main user queue 230 may exist in a number of configurations, including a single queue on a single server, a single queue distributed between multiple physical and/or virtual locations, or multiple collocated or distributed queues. Further, the main user queue 230 may be stored in various forms including a flat file, a relational database, a priority queue, a last-in-first-out queue, a first-in-first-out queue, or a sorted queue.

One or more users receive data from the main user queue 230 for the second tier of review. The users may receive data records individually or in batches. Batches may be of any useful number. Batches may be stored in individualized queues 230-1, 230-2, and 230-3, which may be user-specific or shared between multiple users. Further, data may be distributed to the individualized queues 230-1, 230-2, and 230-3 by any useful algorithm, including by random, load balancing, authority, difficulty, etc.

After a user receives her records for review, the user reviews 232 each record. Of course, in certain cases, it may be possible for a user to review multiple records simultaneously based on common characteristics or other algorithms. When the user reviews 232 each record, the user enters a decision point 234. At this decision point 234, the user determines whether or not the record appears clean. If the user determines that the record is clean, the record is sent 234-1 to quality control for a third tier of review. If the user either cannot make a determination regarding the record, or if the user believes the record is suspect, the record is sent 234-2 to management for a third tier of review.

To facilitate routing records, auditing records, or for any other purpose, the records may be marked or identified in some way to reflect the determination of the user. For example, depending where the user determines that the record should be sent, 234-1 or 234-2, the record may be marked “Q” (for quality control) or “H” (for hold), respectively. This record marking or identification may be done manually by the user or automatically, based at least in part on the user's determination. Further, the user's determination may be accompanied by additional information as a required part of the process or as desired. For example, the user may be unable to tell if a record is clean or suspect, and may want to attach a message to the third-tier reviewer relating the reasons for this uncertainty.

After making a determination for each record or group of records, another decision point 236 may be reached to determine whether more records remain in the user's queue. This would most likely occur where the user receives batches of records at a time. For instance, the user may receive 50 records at a time in her queue. After reviewing each record, this decision point 236 is reached, asking whether the 50 records have been reviewed. If all records in the user's queue have not bee reviewed 236-1, the user continues to the next record. If all records in the user's queue have bee reviewed 236-2, the user receives 230-1 a new batch of records from the main user queue 230.

It will be appreciated that the users in this second tier of review could be human, automated, or some combination of users. Further, some parts of the process may be manual and others may be automated. For example, the user may be a human working at a computer terminal. From the user's perspective, a first record may appear on her terminal screen; she may quickly determine based on information on the screen whether to mark the record as “Q” or “H”; then that first record may disappear and a second record may appear. From the method's perspective, however, automated systems may be working in the background to perform queuing, information processing, display, routing and other functions.

Records which are sent 234-1 to quality control for a third-tier review pass through connector Q 238 to FIG. 2C.

FIG. 2C begins the quality control review of records at connector Q 238 by passing records to the quality control queue 240. This quality control queue 240 may be a single queue or multiple quality control queues 240-1, 240-2, etc. Quality controllers may also receive records individually, as they arrive from the user review. A sample of records may then be selected 242 for review. This sample may be selected 242 randomly or by any other means, and may comprise any one or more of the records in the quality controller's queue (e.g. 240-1). This sample may then be stored in a separate sub-queue 244 for review.

As with the user queues 230 (FIG. 2B), the quality control queues 240 and sub-queues 244 may be configured in many different ways. Among these ways, queues and sub-queues may be collocated or distributed, and/or data may be allocated using various types of algorithms.

Quality controllers review 246 each record in a quality control sub-queue to determine whether the user's review appears correct. Note that, depending on the embodiment, quality control may review some, all, or even none of a user's records for any number of reasons. Typically, however, the quality control sub-queue 244 would contain a small sampling of the records which the user initially determined were clean. Then, the quality controller would have the opportunity to review 246 this sampling as representative of the entire set of data coming from a user or a batch of records. The review would then enter a decision point 258 to determine whether the record or records passed the review.

If records fail 248-1 the quality control review, they are sent back to the second-tier user review through connector B 252 (which connects to FIG. 2B). Before being sent back to the user queue, however, the records may be marked 250 to indicate the failed quality control review. This marking may show up as a visual cue for the user who receives the record (e.g. the record may be highlighted, have different color font, etc.). Additionally or alternatively, the marking may cause the record to be prioritized by the user's queue. This prioritization may then cause the record to appear to the user in a different order, with different types of information, or in some other way.

If, on the other hand, records pass 248-2 the quality control review, information is updated 254 to the method 200. This updating 254 may comprise updating record attributed in the GSS system, sending the records to a different database for cleared records, or some other useful method. Further, the first-tier review (software, generally) may then be updated 256 to reflect records which passed the review. Updating 256 the software may further include using information from the cleared record or the review process to improve the first-tier review algorithms. Once the records have been cleared and the method 200 has been updated, the method 200 may terminate 258.

Returning to FIG. 2B, for records which are sent 234-2 to management for a third-tier review pass through connector H 260 to FIG. 2D.

FIG. 2D begins the management review of records at connector H 260 by passing records to the hold queue 262. This hold queue 262 may be a single queue or multiple hold queues 262-1, 262-2, etc. Managers may also receive records individually, as they arrive from the user review.

Generally, this third-tier manager reviewer will have higher or different authority than the second-tier user reviewer. As part of this authority, the manager reviewer may have access to certain research tools 266. These research tools 266 may include access to certain databases and files, specialized knowledge, etc. For example, research tools 266 may include general purpose tools, like LexisNexis®, Google, Yahoo, and company websites; and specific tools, like the One Name List (ONL, a detailed list of all stop descriptors with multiple name matched on the SDN list), Taliban Research Lists (TRL and TRL2, lists with detailed information on Taliban and related entities), and archive data (lists of previously made decisions on similar data, etc.). The manager reviewer reviews 264 each record from the hold queue 262, at least in part by using the research tools 266.

Based on this review 264, the manager reviewer may desire or may be require to update 268 comments to the record. These comments may contain, among other things, a determination regarding the record, or other useful information relating to reasons for or against a particular determinations. After updating 268 the record, a decision point 270 is reached, asking whether the manager reviewer was able to make a determination.

If the manager review is unable 270-1 to make a determination, the record may be sent to another manager with different or higher authority. This second-level manager reviewer may then continue the review process by re-reviewing 264 the record. In this review, the second-level manager reviewer may use the same or different research tools 266 and may also find the comments of the first-level manager reviewer useful.

Once a manager reviewer is able 270-2 to make a determination, records are updated 272 to the method 200. This updating 272 may comprise updating record attributed in the GSS system, sending the records to a different database for cleared or suspect records, or some other useful method. Further, the first-tier review (software, generally) may then be updated 274 to reflect records which passed the review. Updating 274 the software may further include using information from the cleared record or the review process to improve the first-tier review algorithms. Once the records have been cleared or blocked and the method 200 has been updated, the method 200 may terminate 276.

By way of a first example, say a given record is sent to the method 200 provided by FIGS. 2A-2D. This record reflects a transaction, in which one party is a business named Cub Scouts of America. This record is compiled 202 for OFAC screening and sent to the GSS system which receives 204 the record. The file format is checked 206 and determined to be correct 206-2. The record is then run 216 through the Accuity software, where it is screened 218 against Accuity's rules and algorithms. The screening process is successful 220-2, and the record is stored 222 in the GSS OFAC database. Based on sensitive rules and algorithms, the software determined that the word “Cub” was close enough to the word “Cuba,” and marked the record as suspect.

The suspect record is passed 226 to the user queue and onto the second tier of review. From the main user queue 230, the data is allocated to the individualized user queue of User A 230-1. User A reviews 232 the record and determines that the word “Cub” has nothing to do with the sanctioned country “Cuba.” Based on this determination, the user then decides to mark the record with a “Q” 234-1 and sends the record to quality control for sign-off.

Quality control receives the record in its queue 240. Because there is only a single record in this case, there is no need for sampling 242 or for a sub-queue 244. A quality controller reviews 246 the record and determines that the user appears to have made a proper determination 248-2. The database is then updated 254 to reflect that the record has been cleared. Further, the Accuity software is updated 256 to reflect that “Cub Scouts of America” has been cleared and should no longer be considered a match with the word “Cuba.” The method 200 then terminates 258.

By way of a second example, a different record is sent to the method 200. This record reflects a transaction, in which one party is a business named Cuba Holdings (a fictional company). This record is compiled 202 for OFAC screening and sent to the GSS system which receives 204 the record. The file format is checked 206 and determined to be correct 206-2. The record is then run 216 through the Accuity software, where it is screened 218 against Accuity's rules and algorithms. The screening process is successful 220-2, and the record is stored 222 in the GSS OFAC database. Because the word “Cuba” was found in the record, the record was identified during the screening process as suspect.

The suspect record is passed 226 to the user queue and onto the second tier of review. From the main user queue 230, the data is allocated to the individualized user queue of User A 230-1. User A reviews 232 the record and determines that the word “Cuba” is, indeed, an integral part of one of the party's names, making the transaction suspect. The user then decides to mark the record with an “H” 234-2 and to send the record to management for further review.

Management receives the record in its hold queue 262, from which it is pulled for review by a first-level manager reviewer. The first-level manager reviewer reviews 264 the record at least in part by consulting certain research tools 266. One of these research tools 266 is a company information database. From this database, the manager reviewer learns that Cuba Holdings is an investment consulting firm, which specializes in financial planning for legal Cuban immigrants to the United States.

At this point, the manager reviewer has two options. In the first option, the manager reviewer may decide that this is enough information to either block or clear the transaction. In this case, manager reviewer would update 272 the record and update 274 the software to reflect this determination, and the process would terminate 276. In the second option, the manager reviewer may decide that there is not enough information in his research tools 266 with which to make a proper determination. In this case, the manager reviewer would send the record to a second-level manager reviewer for further review.

Assuming the second option is chosen, the second-level manager reviewer would look for more research on Cuba Holdings. The second-level manager reviewer's research may further show that Cuba Holdings participates in many legitimate financial transactions, and has never been accused or suspected of engaging in government-sanctioned activities. This second-level manager reviewer may now decide that enough information is available to determine that the transaction is clean. Once again, after a determination is made, the second-level manager reviewer would update 272 the record and update 274 the software to reflect this determination, and the process would terminate 276.

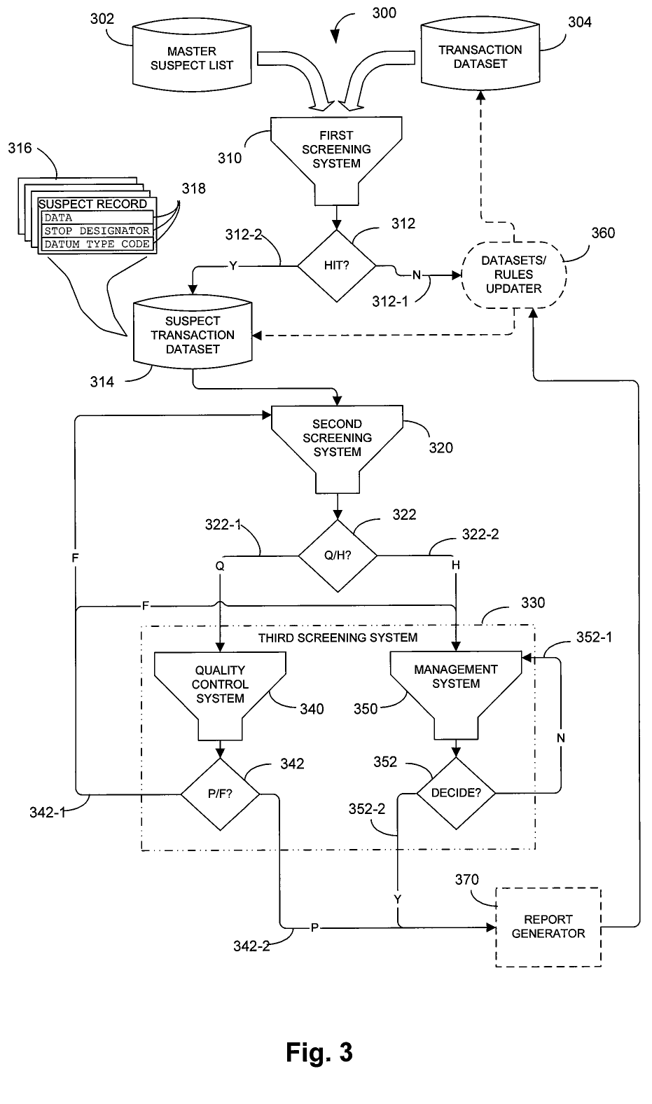

FIG. 3 provides a system block diagram illustrating systems for executing multi-tiered methods of removing false positives from a suspect transaction dataset according to various embodiments of the invention. The components and configuration of the system intends to be construed as broadly as possible, incorporating at least the various embodiments discussed with reference to FIGS. 1 and 2.

The system 300 comprises at least three tiers of sub-systems, including a first screening system 310, a second screening system 320, and a third screening system 330. A master suspect list 302 and a transaction dataset 304 are stored so that the first screening system 310 can access the data. The master suspect list 302 may be any master list against which the transaction dataset 304 may be screened. For example, the master suspect list 302 may comprise the OFAC lists, lists of known felons, lists of previously-identified fraudulent actors, etc. The transaction dataset 304 may be any set of data which an organization desires to screen.

These data are passed to the first screening system 310, which determines 312 whether there is a hit. As explained above, hits may be determined in many different ways, and often the first screening system 310 outputs a high percentage of false positives. Records which pass through the first screening system 310 without a hit 312-1 may be ignored. If necessary or desirable, information may be passed to an updater 360 which updates databases and rules accordingly.

Records which generate a hit 312-2 in the first screening system 310 are stored as part of a suspect transaction dataset 314. The suspect transaction dataset 314 may contain suspect records 316. Each suspect record 316 may contain various attributes 318, including, for example, data, a stop designator, and a datum type code.

The second screening system 320 has access to at least a portion of the suspect transaction dataset 314. The second screening system 320 uses this and other data to make a second-tier determination regarding each record (or group of records). The output of the second screening system 320 may be a determination 322 of what type of third screening system 330 is necessary or desired. For example, the determination 322 may be that quality control is needed 322-1 or that management review is needed 322-2.

If quality control is needed 322-1 (e.g. the record was determined to be clean, or a false positive), the record is sent to the quality control system 340. If the record fails 342-1 in the quality control system 340, the record and or other information may be sent either back to the second screening system 320 or over to the management system 350. If the record passes 342-2 is the quality control system 340, the record and or other information may be sent to a report system 370 and/or an updater 360. The report system 370 may generate any type of useful report based at least in part on the multi-tiered screening systems 310, 320, and 330. The updater 360 may update various datasets and rules to reflect the results of the multi-tiered screening systems 310, 320, and 330.

If management review is needed 322-2 (e.g. the record was determined to be suspect, or a proper determination could not be made), the record is sent to the management system 350. If management is unable to make a determination 352-1, the record and or other information may be sent back to the management system 350 for another iteration of review. If management is able to make a determination 352-2, the record and or other information may be sent to a report system 370 and/or an updater 360. The report system 370 may generate any type of useful report based at least in part on the multi-tiered screening systems 310, 320, and 330. The updater 360 may update various datasets and rules to reflect the results of the multi-tiered screening systems 310, 320, and 330.

It will be appreciated that, in addition to the system configuration described by FIG. 3, many other configurations are possible for performing the various embodiments of the invention. For example, system components may exist in series or in parallel; components may be manual or automated with varying degrees of human and non-human interface; and data may be stored in many different useful formats and locations. Further, it may be possible to add, remove, or rearrange components, while maintaining or improving the efficacy of the system in performing embodiments of the invention.

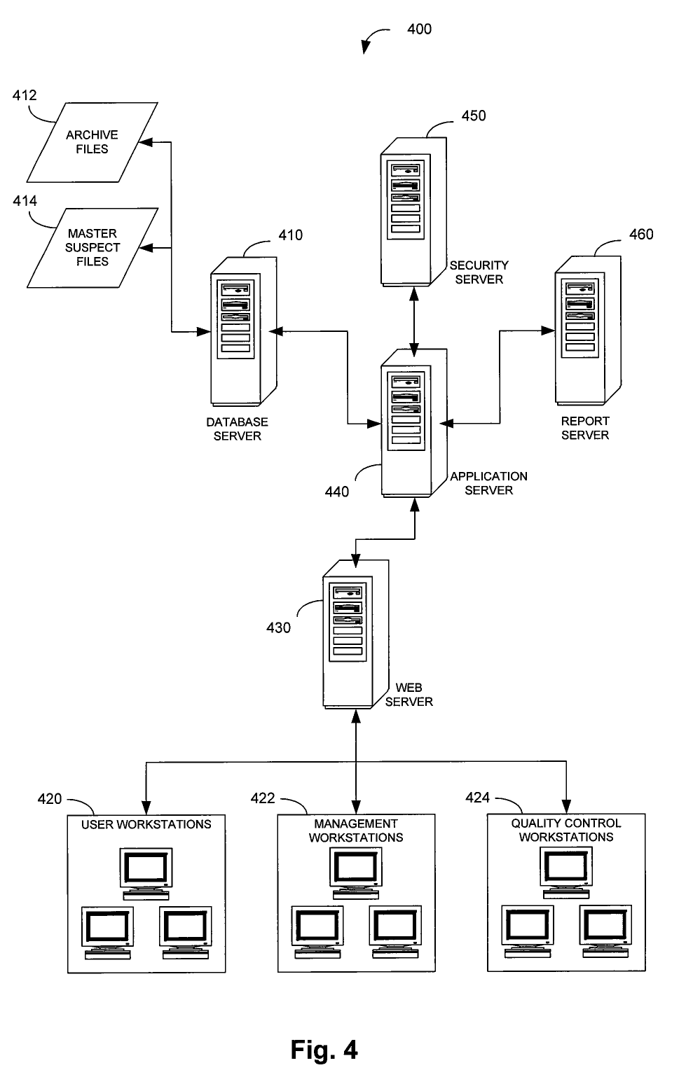

FIG. 4 provides an illustrative block diagram illustrating a system for removing false positives from a suspect transaction dataset according to various embodiments of the invention. In this system 400, a network of servers and workstations are communicatively coupled to screen suspect data. A database server 410 has access to archive files 412 and master suspect lists 414.

To review a suspect record, a user may sit at a user workstation 420. The user may then log on to the web server 430 which is communicatively coupled with the user's workstation 420. Through the web server 430, the user may access the screening application stored on (or accessible through) the application server 440. The application server 440 may then download or access appropriate data from the database server 410. In a similar way, applications and data may be accessed through the various servers 430, 440, and 410 from other types of workstations, including management workstations 422 and quality control workstations 424.

Further, access to applications and data, and other aspects of the system may be controlled in part by the security server 450. The security server 450 may be part of a larger security system, which may employ both physical and virtual security measures, as desired or required. Additionally, the report server 460 may be used to generate reports of data for audits, compliance, communications, or many other reasons. This report server 460 may be accessible through the application server 440 or by some other means.

It will be appreciated that many similar configurations are possible. For example, the entire system may be configured as physical or virtual spokes around a secure web server hub. Alternately, the entire system may exist as hardware and/or software components in a single computer.

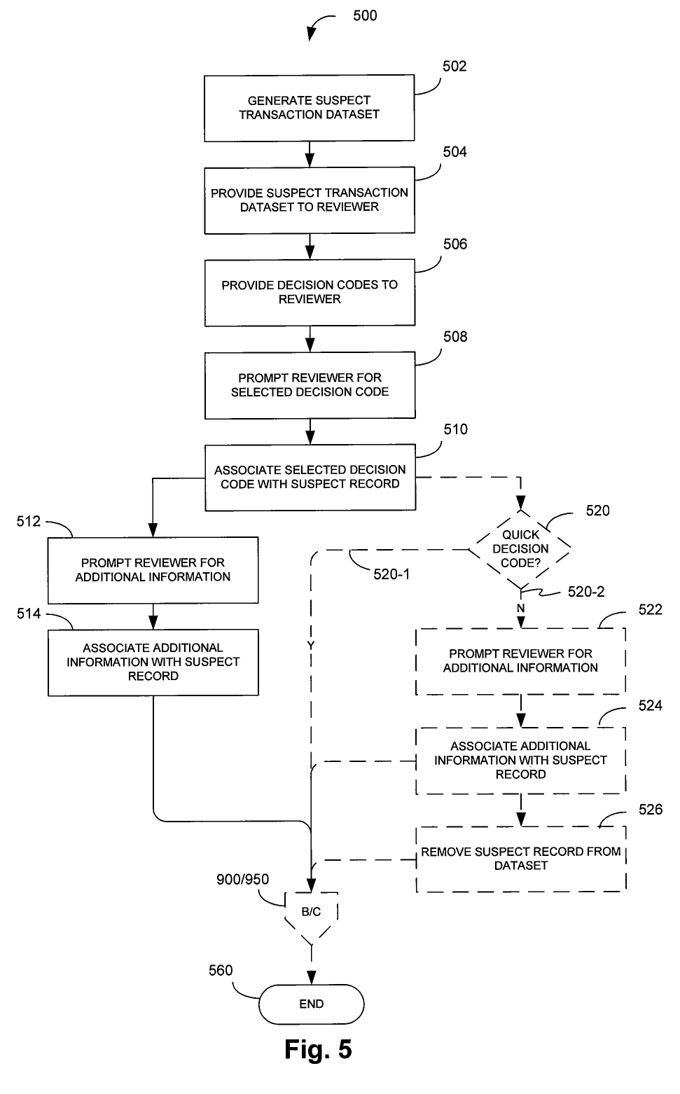

Among other things, FIGS. 5-7 describe various embodiments of one tier of multi-tiered screening methods and systems for removing false positives from a suspect transaction dataset according to various embodiments of the invention. More particularly, FIG. 5 provides a flow diagram summarizing methods of removing false positives from a suspect transaction dataset according to various embodiments of the invention.

The method 500 begins when a suspect transaction dataset is generated 502. This dataset may be generated 502 manually or automatically. Further, generating 502 this dataset may be part of this screening tier or may be the result or part of a previous screening tier. The dataset is provided 504 to a reviewer, and a set of decision codes are provided 506 to the reviewer.

The set of decision codes may include any types of codes which are useful to the types of decisions made by the reviewer. For example, decision codes may include “No Name Match,” “No Date of Birth Match,” “No Social Security Number Match,” “No Entity Type Match,” “Deactivated Merchant/Closed Account,” “Investigation,” and “Solid Identifier Rule.”

The first four exemplary decision codes represent a determination that certain suspect data from the suspect transaction dataset does not match data from the master suspect list. For example, as above, the word “Cub” in “Cub Scouts of America” may generate a false positive if the screener determines that the word is too close to “Cuba.” A quick review would show that the names do not really match (“Cub” vs. “Cuba”) and the entity types do not match (“Cub” is part of a business name vs. “Cuba” is a country name). In another example, “Mr. Hassan” may match a number of entries in the OFAC lists. On further examination, a reviewer may determine that the social security numbers, dates of birth, and other information do not match.

A “Deactivated Merchant/Closed Account” code may represent that a party to a transaction does not have a valid account. This may alert an institution to fraudulent activity, or at least create a motivation to investigate. An “Investigation” code may represent that the transaction requires further investigation. A “Solid Identifier Rule” code may represent a specific rule has been triggered. For example, a special rule may be triggered whenever a name on the OFAC list is associated only with a first and last name and no other information, and the corresponding hit from the suspect transaction dataset matches the name and is associated with other information (date of birth, social security number, address history of living in the United States, etc.).

The reviewer is prompted 508 to select a decision code, which is then associated 510 with the suspect record. It will be appreciated the many different types of decision code may be desirable for different types of suspect records and scenarios. Further, it will be appreciated that the method may alter based on the scenario, record type, code selected, codes provided, and other variables.

The method 500 illustrated in FIG. 5 proceeds in one of two paths, depending on the selected decision code. The first path assumes that decision codes require further information before a final determination can be attempted. In this path, the reviewer is prompted 512 for more information relating, for example, to the selected decision code or the possible determination. This information is then associated 514 with the suspect record. The record, information, and/or any other useful information may then be passed to another reviewer, as indicated by connector B/C 900/950. Then, or alternatively, the method may terminate 560.

The second path allows for quick decision codes, which may allow for a preliminary or final determination without the need for further information. The path begins at a decision point 520, where it is determined whether a quick decision code has been selected. It will be appreciated that different organizations and situations may influence which types of codes may be quick decision codes. Further, the quick decision code may be its own decision code, or a category of one or more other decision codes.

For example, say the suspect transaction dataset indicates that the word “Hassan” appeared in a suspect record. Upon review, the reviewer may find that Hassan is in the OFAC list as the name of a known international terrorist. The transaction record, however, shows that the transacting party in question is a company located at 1234 Hassan Street. This may be enough information for the reviewer to decide that the business address of “Hassan Street” has no connection to the international terrorist, and the transaction should be cleared by quick decision.

If a quick decision code has been selected 520-1, the method may pass the record, information, and/or any other useful information to another reviewer, as indicated by connector B/C 900/950. Then, or alternatively, the method may terminate 560.

If a quick decision code has not been selected 520-2, the reviewer may be prompted 522 for more information, and that information may be associated 524 with the suspect record. Additionally or alternatively, if the quick decision code so reflects, a suspect record may be removed 526 from the suspect transaction dataset. In either case, the method may pass the record, information, and/or any other useful information to another reviewer, as indicated by connector B/C 900/950. Then, or alternatively, the method may terminate 560.

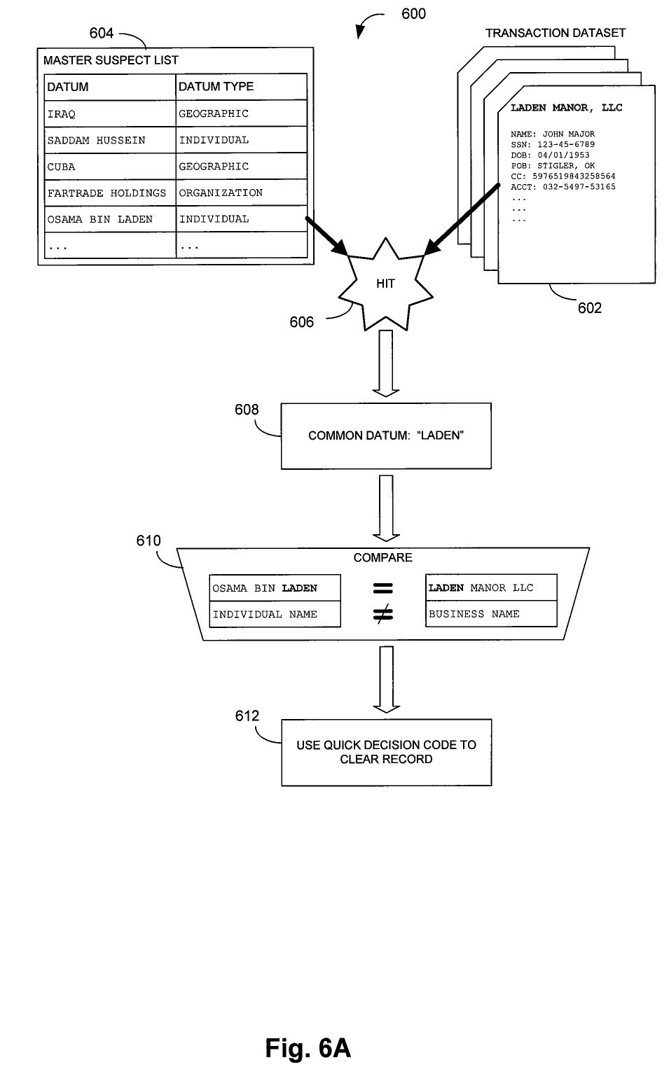

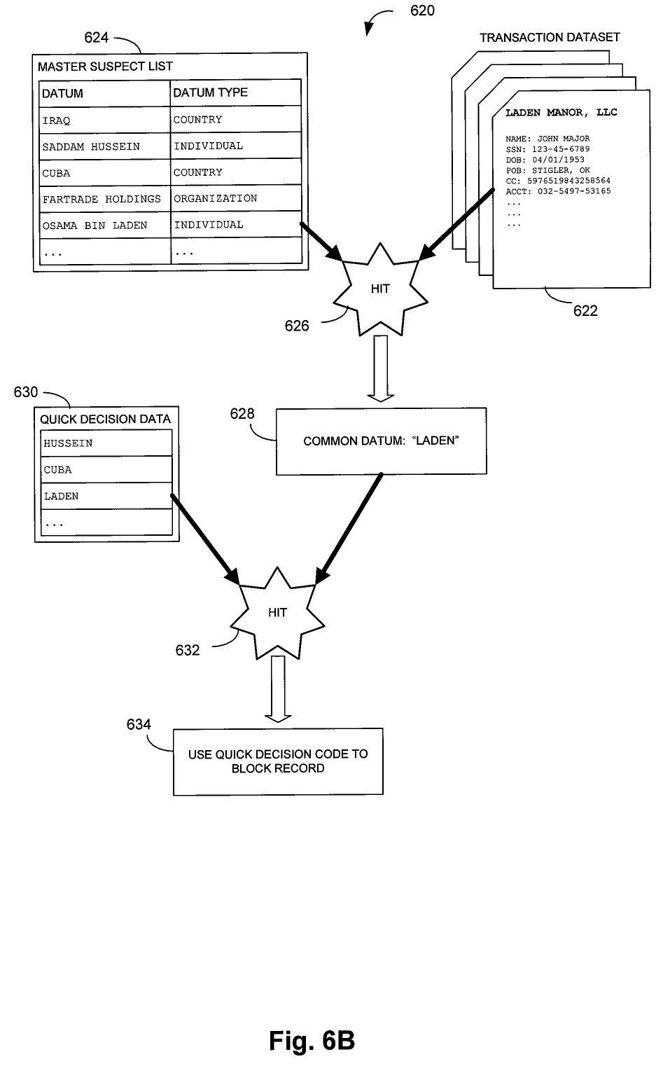

FIG. 6A provides an exemplary flow diagram summarizing methods of using quick decision codes to clear hits in a suspect transaction dataset according to various embodiments of the invention. The flow diagram 600 begins with a comparison between a transaction dataset 602 and a master suspect list 604. During the comparison, one record in the transaction dataset 602 is found to contain a party named “Laden Manor, LLC.” An entry in the master suspect list 604 contains the name “Osama Bin Laden.” Because both lists contain the common datum 608 (“Laden”), the comparison detects a hit 606.

This common datum 608 may then be included in the master suspect dataset and reviewed by a reviewer. The reviewer may analyze the hit to determine if it is a false positive, by comparing 610 aspects of the hit. First, the reviewer may look at the allegedly common term and determine that both records do, in fact, contain the exact same term, “Laden.” This may not be the case if, for example, the system were very sensitive, finding a hit between terms like “Laden” and “Lading.” Second, the reviewer may compare the datum types and find that Laden refers to an individual's name in the master suspect list 604 and to a business name in the transaction dataset 602. Because the entity types do not match, the reviewer may decide that a quick decision code is appropriate to clear the record 612 (i.e. determine that the hit is actually a false positive). It will be appreciated that in many cases, this comparison would not provide enough information to clear the record, and the reviewer may not even have the authority to clear a record.

FIG. 6B provides an exemplary flow diagram summarizing methods of using quick decision codes to block hits in a suspect transaction dataset according to various embodiments of the invention. The flow diagram 620 begins with a comparison between a transaction dataset 622 and a master suspect list 624. During the comparison, one record in the transaction dataset 622 is found to contain a party named “Laden Manor, LLC.” An entry in the master suspect list 624 contains the name “Osama Bin Laden.” Because both lists contain the common datum 628 (“Laden”), the comparison detects a hit 626.

This common datum 628 may then be included in the master suspect dataset and reviewed by a reviewer. At this point, the common datum 628 may be compared to a list of quick decision data 630. This quick decision data list 630 may contain terms or other information which has been determined to require automatic action. Here, the common datum 628 is found to match a term in the list of quick decision data 630. The result is that another hit 632 occurs, and the record is blocked 634 with a quick decision code. It will be appreciated that, in cases like this, the entire determination may be made automatically with no input from the reviewer. Further, it may be desirable that in these cases, the record may not even enter the reviewer queue.

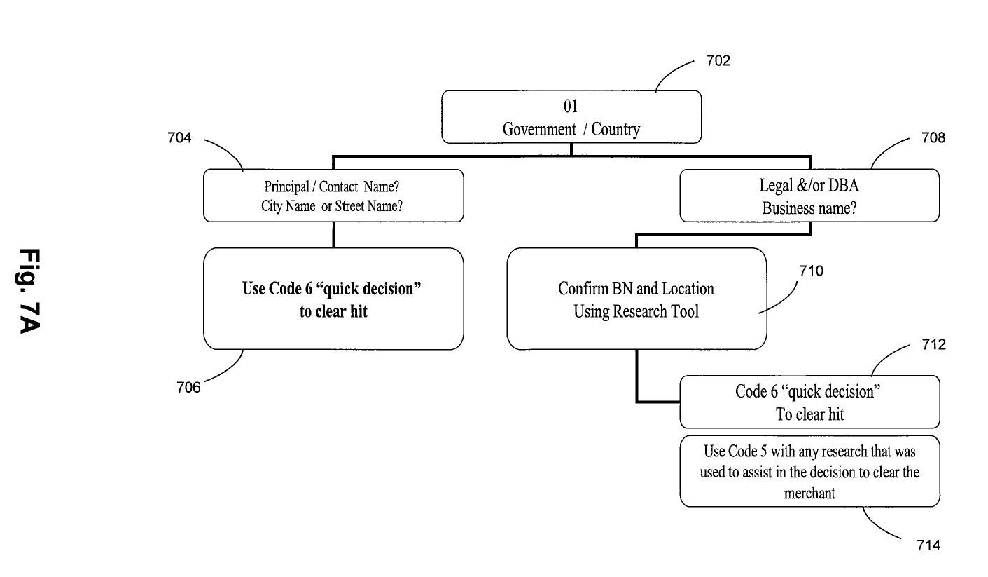

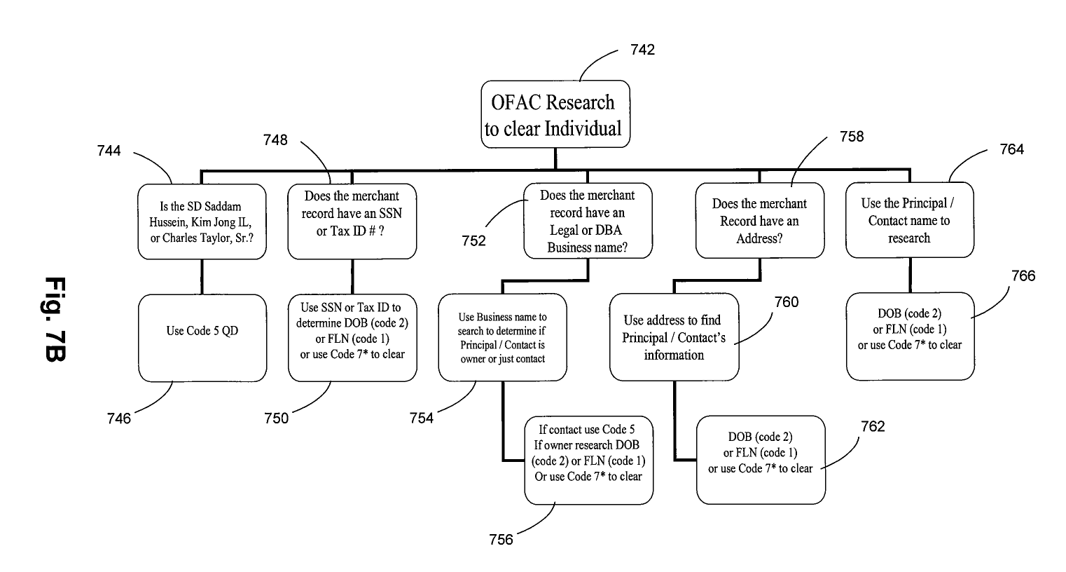

Other exemplary decision trees to be used by a reviewer are provided by FIGS. 7A and 7B.

FIG. 7A provides a decision tree which may be used by a reviewer when the entity type 702 of the datum from the master suspect list represents a government or country. For example, the datum “Cuba” may be a suspect country or government in the OFAC list. First, the reviewer may check the entity type of the allegedly common datum in the transaction dataset. If this entity type is a principal, contact, city, or street name 704, the reviewer may use a quick decision code to clear the hit 706 as a false positive. For example, if the contact name is “John Cuba” or the address is “123 Cuba Court,” the record may be cleared.

If the entity type of the datum from the transaction dataset is a legal and/or DBA (“doing business as”) name of a business 708, the reviewer may have to do more research, like checking the business name and location 710. Assuming that the business name and location are not suspect, the reviewer may then use a quick decision code to clear the hit 712 as a false positive. The reviewer may alternately or additionally use a decision code to add information to the record 714. This added information may either justify the use of the quick decision code or provide more information for another tier of screening. For example, a business named Cuba Cuisine may not be suspect if the business is located in the United States. On the other hand, a business named “Travel Cuba” may require further research, as the name may indicate its involvement in suspect or sanctioned transactions.

FIG. 7B provides a decision tree which may be used by a reviewer to clear a record when the entity type of the datum from the master suspect list represents an individual 742. For example, the datum “Hassan” may be a name or alias of a suspect individual in the OFAC list. First, the reviewer may check to see if the name matches a high priority list 744 of individual names which always results in an automatic block of the transaction. If so, a special quick decision code 746 may be used with or without additional information. Here, “Hassan” does not match any names in the high priority list 744.

Next, the reviewer may check to see whether the merchant record contains a social security number or tax identifier 748 for the individual. If so, the reviewer may use the social security number or tax identifier 748 to get more personal information on the individual and to see if the other personal information matches. For example, the reviewer may check the full names, dates of birth, social security numbers, etc. If these do not appear to match, the reviewer may be able to assume that the transacting individual and the sanctioned individual are different people. At that point, the reviewer may be able to clear 750 the record.

Next, the reviewer may check to see whether the merchant record contains a legal and/or DBA name 752 for the business. If so, the reviewer may use the business name 752 to get more information about how the individual is related 754 to the business. Based on this relationship, the reviewer may be able to clear 756 the record. For example, if the individual is just a contact in the company, the reviewer may be able to clear the transaction record. However, if the individual is the owner of the business, more research may be required into the details of the owner to see if the record should be blocked or cleared.

Next, the reviewer may check to see whether the merchant record contains an address 758 for the business. If so, the reviewer may use the address 758 to get more information on the business, like information on the principal or contact 760. At this point, the reviewer may check the full names, dates of birth, and other information to see if the record can be cleared 762.

Finally, the reviewer may check into further information regarding the individual 764 represented by the datum. At this point, as above, the reviewer may check the full names, dates of birth, and other information to see if the record can be cleared 766.

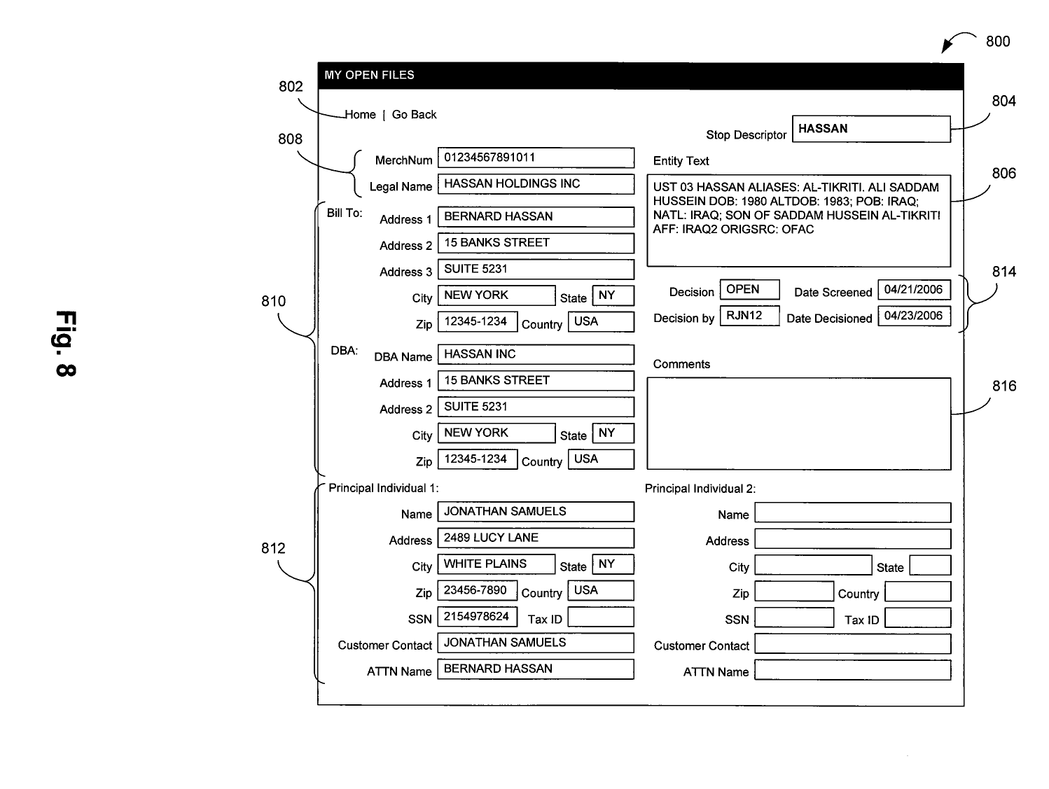

FIG. 8 provides an exemplary reviewer interface screen with which a reviewer may screen suspect files according to various embodiments of the invention. Purely by way of example, the interface 800 is shown with a common type of look and feel found in many applications, including various operating systems, web browsers, and other applications. The interface 800 is also shown with web browser-type of navigation functionality, including “home” and “go back” buttons 802.

Various types of information are provided on this exemplary interface 800 for a reviewer. First, the stop descriptor 804 is provided to clearly signal the suspect datum in question. Second, entity text 806 is provided to give more information regarding the stop designator. In the example illustrated, the entity text 806 contains information like an entity type code (“03” may indicate that the stop designator refers to an individual's name), aliases, date of birth, place of birth, nationality, and other personal information.

The interface 800 also may provide information about the suspect transacting party for comparison. First, record filing information 808 like merchant number and legal name may be provided. Second, business address information 810 may be provided, like billing addresses and DBA addresses. Third, principal information 812 may be provided, like principal and contact names, addresses, social security numbers, tax identifiers, etc.

Further, the interface 800 may provide information regarding the screening process. First, screening data 814 may be provided, including the current decision, screening date, decision date, and an identifier for the individual who made the decision. Second, a comment field 816 may be provided for entering additional information regarding the record and the screening process.

It will be appreciated that many different types of look and feel may be used to support the various embodiments of the invention. It may also be desirable to have different fields, menu structures, and other elements. Further, the amount of automation at each stage of the process may influence how users interface with the invention. Additionally, it will be appreciated that different tiers and different screeners may have access to the same or different interfaces as needed or desired.

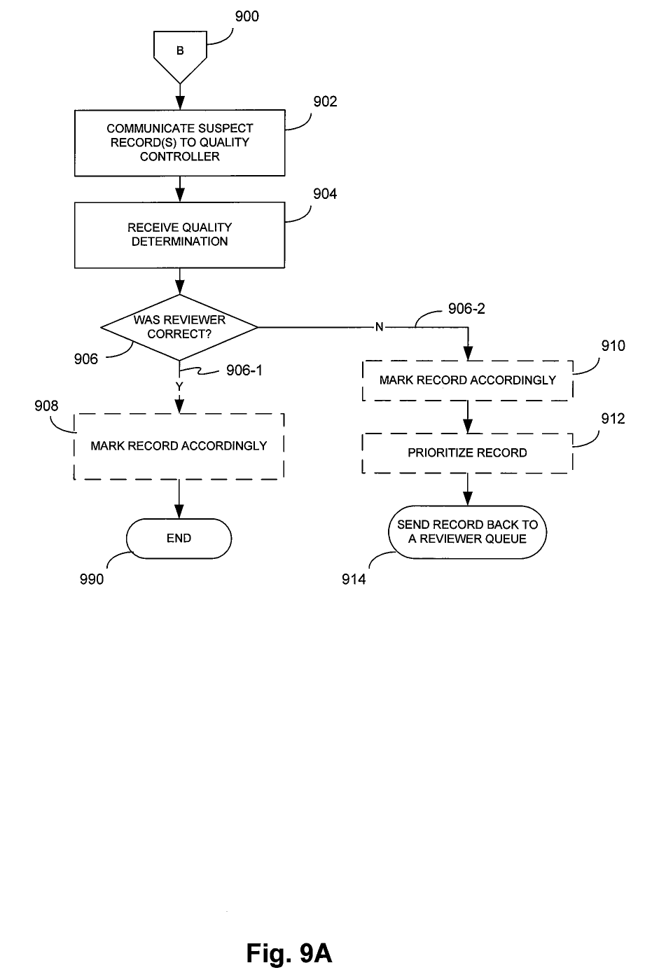

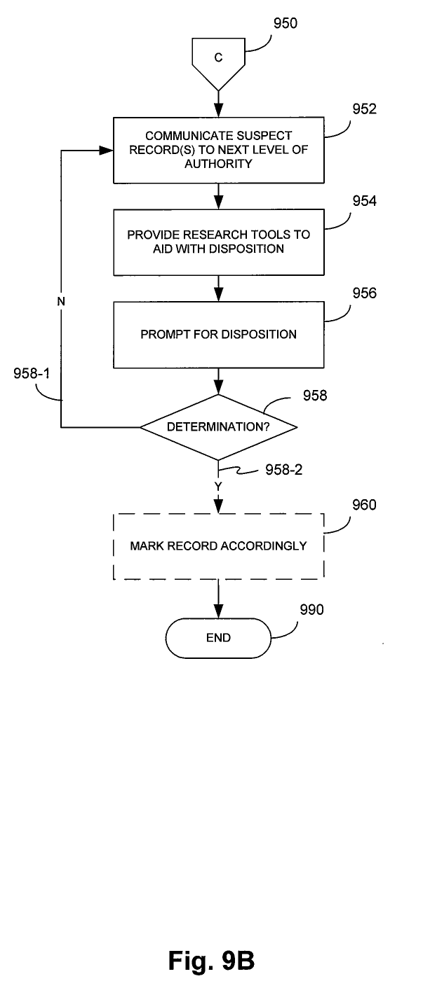

If the method passes information to another reviewer (see FIG. 5, connector B/C 900/950), some embodiments of the method may proceed with FIGS. 9A and/or 9B.

FIG. 9A provides a flow diagram summarizing additional methods of using quality control to help remove false positives from a suspect transaction dataset according to various embodiments of the invention. The method begins with connector B 900, when the suspect record or records are communicated 902 to a quality controller. The method receives 904 a quality determination from the quality controller.

In some embodiments, this quality determination may reflect whether the initial determination made by the previous reviewer appears to be correct. In making this determination, the method reaches a decision point 906. If the reviewer's initial determination appears to be correct 906-1, the suspect record or records may be marked 908 accordingly. The method may then terminate 990.

If the reviewer's initial determination appears to be incorrect 906-2, the suspect record or records may be marked 910 accordingly. This marking may indicate that the reviewer's determination appears incorrect, and/or may provide other useful information for the record. Further, the marking may be made in a number of different ways, including, for example, changing font size, color, or weight, or adding information to record fields. Based on this determination or marking, the record may be prioritized 912 and sent 914 back to the reviewer queue for further review.

Alternately, the record and or other information may be sent to a different queue for some other reason. For example, the record and the former reviewer's name may be sent to the management queue to alert management to the incorrect determination of that reviewer. For a different example, the record may be sent to the management queue because certain attributes of the record will make proper determination difficult if done by anyone other than management.

FIG. 9B provides a flow diagram summarizing additional methods of using next levels of authority to help remove false positives from a suspect transaction dataset according to various embodiments of the invention. The method begins with connector C 950, when the suspect record or records are communicated 952 to a next level of authority. For example, this next level of authority may be a manager with different authority and/or access, or even an automated system with different system-level authority. The next level of authority may be a higher level or a different level of authority.

The next level of authority is provided 954 with a set of research tools to aid in making a disposition. This disposition may reflect whether a proper determination can be made on the suspect record. The next level of authority is then prompted 956 for a disposition and a decision point 958 is reached.

If the disposition reflects that a determination could not be made 958-1, information is passed to another next level of authority. This may be a reviewer with even more or different information from the previous level of authority. If the disposition reflects that a determination could be made 958-2, the record is marked 960 to reflect that determination. The method may then terminate 990.

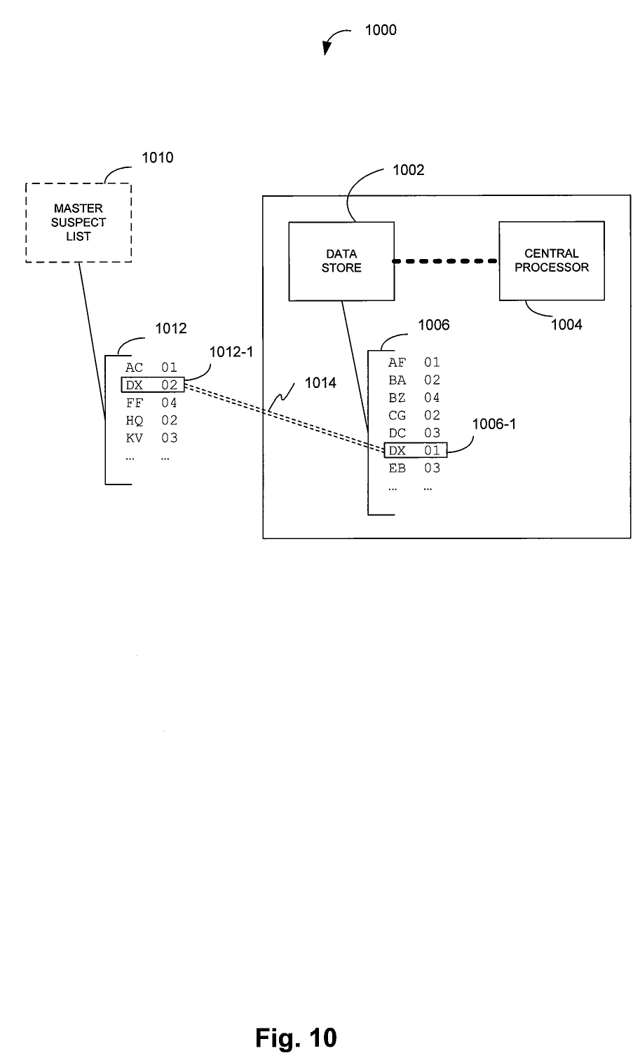

FIG. 10 provides a system diagram illustrating exemplary relational data records which may be used with various embodiments of the invention. The components and configuration of the system intends to be construed as broadly as possible, incorporating at least the various embodiments discussed with reference to FIGS. 5-9.

The system 1000 comprises at least a data store 1002 and a central processor 1004, communicatively coupled with one another. The data store 1002 contains data records 1006, each of which contains one or more attributes. As illustrated, the records 1006 are stored in a relational data structure, like an array. Further, as illustrated, each record 1006 contains at least two attributes, a datum and a datum type code. For example, one record 1006-1 contains the datum “DX” and datum type code “01.” The datum type code may represent any datum type, including, for example, “individual name” or “country name.”

Either within the system or separate from the system, there exists a master suspect list 1010. This master suspect list 1010 also contains data records 1012. As illustrated, the records 1012 are similar to those stored in the data store 1002—they are stored in a relational data structure and each contains at least two attributes, a datum and a datum type code. These records 1006 and 1012 may be compared 1014 to each other. In the illustrated case, records 1012-1 and 1006-1 are determined to contain the common datum “DX.” Further comparison, however, may yield that the datum type codes are different (one is “01” and the other is “02”).

It will be appreciated that, in addition to the system configuration described by FIG. 10, many other configurations are possible for performing the various embodiments of the invention. For example, system components may exist in series or in parallel; components may be manual or automated with varying degrees of human and non-human interface; and data may be stored in many different useful formats and locations. Further, it may be possible to add, remove, or rearrange components, while maintaining or improving the efficacy of the system in performing embodiments of the invention.

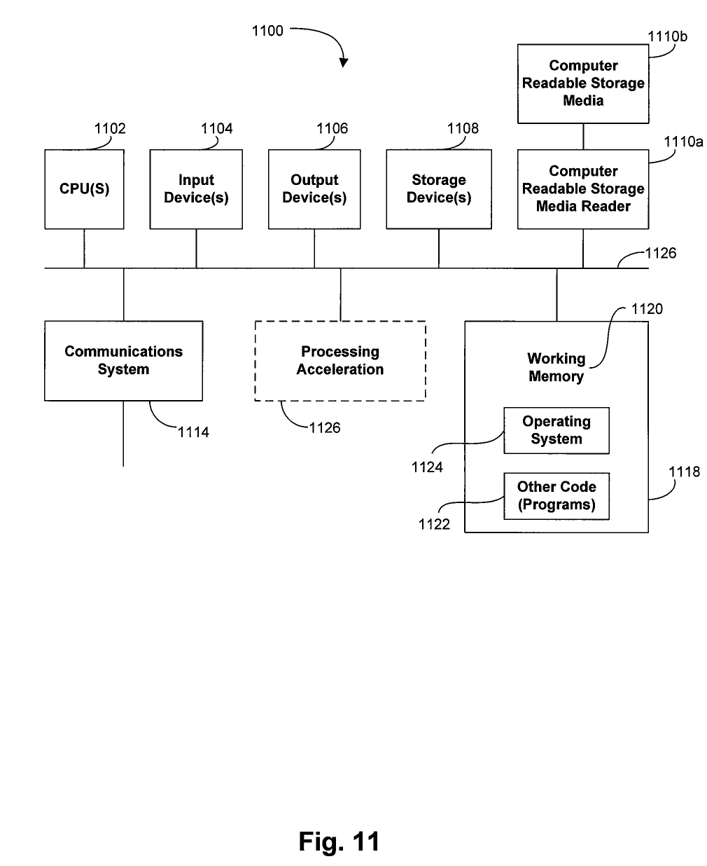

FIG. 11 provides a system block diagram illustrating computational devices for single- or multi-tiered removal of false positives from a suspect transaction dataset according to various embodiments of the invention. FIG. 11 broadly illustrates how individual system elements may be implemented in a separated or more integrated manner. The computational device 1100 is shown comprised of hardware elements that are communicatively coupled via bus 1126, including a processor 1102, an input device 1104, an output device 1106, a storage device 1108, a computer-readable storage media reader 1110a, a communications system 1114, a processing acceleration unit 1116 such as a DSP or special-purpose processor, and a memory 1118. The computer-readable storage media reader 1110a is further connected to a computer-readable storage medium 1110b, the combination comprehensively representing remote, local, fixed, and/or removable storage devices plus storage media for temporarily and/or more permanently containing computer-readable information. The communications system 1114 may comprise a wired, wireless, modem, and/or other type of interfacing connection and permits data to be exchanged over the architecture described in connection with FIGS. 1 and 4.

The computational device 1100 also comprises software elements, shown as being currently located within working memory 1120, including an operating system 1124 and other code 1122, such as a program designed to implement methods of the invention. It will be apparent to those skilled in the art that substantial variations may be made in accordance with specific requirements. For example, customized hardware might also be used and/or particular elements might be implemented in hardware, software (including portable software, such as applets), or both. Further, connection to other computing devices such as network input/output devices may be employed.

Thus, having described several embodiments, it will be recognized and appreciated that various modifications, alternative constructions, and equivalents may be used without departing from the spirit of the invention. Additionally, depending on the types of data being screened, and the employed methods and systems, different screeners may perform different roles, use and create different data, and interface with other parts of the invention differently. Accordingly, the above description should not be taken as limiting the scope of the invention, which is defined in the following claims.

What is claimed is:

1. A method for screening transaction data against a master suspect list and removing false positives, the method comprising:
generating, with a computer, a suspect transaction dataset comprising a suspect record, the suspect record comprising:
a set of data, at least one of the set of data being a common datum which is substantially identical to a master suspect list datum, both the common datum and the master suspect list datum being of a datum type,
a stop designator representing the common datum, and
a master datum type code designating the datum type of the master suspect list datum;
providing the suspect transaction dataset to a reviewer;
providing, to the reviewer, a set of decision codes comprising a quick decision code;
prompting the reviewer to select a selected decision code from the set of decision codes to associate with the suspect record, the selection being based at least in part on the stop designator and the master datum type code;
associating the selected decision code with the suspect record; and
prompting the reviewer for further information relating to the removal of false positives and associating the further information with the suspect record.

2. The method of claim 1, wherein prompting the reviewer for further information occurs only when the selected decision code is not the quick decision code

3. The method of claim 1, further comprising removing the suspect record from the suspect transaction dataset when the selected decision code is the quick decision code.

4. The method of claim 1, further comprising:
communicating the suspect record to a quality controller to check whether the reviewer selected an appropriate decision code to associate with the suspect record; and
receiving a quality determination from the quality controller.

5. The method of claim 4, wherein the reviewer is a first reviewer; and
further comprising providing the suspect record to a second reviewer when the quality determination reflects that the reviewer selected an inappropriate decision code to associate with the suspect record.

6. The method of claim 4, further comprising marking the suspect record to reflect the quality determination.

7. The method of claim 5, wherein the second reviewer is the first reviewer.

8. The method of claim 4, wherein the suspect transaction dataset is stored in a queue configured to prioritize data based at least on the quality determination.

9. The method of claim 1, further comprising:
communicating the suspect record to a next higher authority;
providing the next higher authority with a first research tool; and
receiving, from the next higher authority, a disposition based at least in part on data from the first research tool and reflecting either a block condition, a clear condition, or a hold condition.

10. The method of claim 9, wherein the next higher authority is a first next higher authority and the disposition is a first disposition, and further comprising:
communicating the suspect record to a second next higher authority when the first disposition reflects a hold condition;
providing the next higher authority with a second research tool; and
receiving, from the second next higher authority, a second disposition based at least in part on data from the second research tool and reflecting either a block condition, a clear condition, or a hold condition.

11. The method of claim 9, further comprising prompting the next higher authority for more information relating to the disposition.

12. The method of claim 9, further comprising marking the suspect record to reflect the disposition.

13. The method of claim 1, wherein the quick decision code is the selected decision code whenever the datum type designated by the master datum type code is different from datum type of the common datum.

14. The method of claim 1, further comprising providing the reviewer with a set of quick decision data; and
wherein the quick decision code is the selected decision code whenever the datum type designated by the master datum type code is substantially equivalent to the datum type of the common datum, and the common datum is substantially equivalent to one of the set of quick decision data.

15. The method of claim 1, wherein each of the datum types is an element of a data type set comprising geographic location, individual name, and business name.

16. A system for screening transaction data against a master suspect list and removing false positives, comprising:
a data store configured to store a suspect transaction dataset comprising a suspect record, the suspect record comprising:
a set of data, at least one of the set of data being a common datum which is substantially identical to a master suspect list datum, both the common datum and the master suspect list datum being of a datum type,
a stop designator representing the common datum, and
a common datum type code designating the datum type of the common datum; and
a control processor interfaced with the data store and associated with a computer readable medium, computer readable medium comprising instructions executable by the control processor to:
provide, to a reviewer, a set of decision codes comprising a quick decision code,
prompt the reviewer to select a selected decision code from the set of decision codes to associate with the suspect record, the selection being based at least in part on the stop designator and the common datum type code,
associate the selected decision code with the suspect record, and
prompt the reviewer for further information relating to the removal of false positives and associating the further information with the suspect record.

17. The system of claim 16, wherein the instruction to prompt the reviewer for further information occurs only when the selected decision code is not the quick decision code.

18. A method for screening a transaction dataset against a master suspect list and removing false positives, the method comprising:
screening the transaction dataset against the suspect list using a first computer comprising a first screener and a first set of screening criteria, and generating a suspect transaction dataset, the suspect transaction dataset comprising a set of suspect data, at least a portion of the set of suspect data being false positives;
screening each suspect datum in at least a portion of the suspect transaction dataset using a second screener and a second set of screening criteria, and generating a set of second screen results, each of the set of second screen results representing either a clean or a suspect condition of a respective screened suspect datum;
screening at least a portion of the set of second screen results to remove at least a portion of the set of false positives using a third screener and a third set of screening criteria, and generating a third screen result; and
updating, using a second computer, the first set of screening criteria based at least in part on the third screen result.

19. The method of claim 18, wherein screening at least a portion of the second screen result further comprises:
evaluating for quality at least a portion of the set of second screen results for which the second screen result represents a clean condition;
generating an evaluation result from the evaluating step, the evaluation result reflecting either an accurate second screen result or an inaccurate second screen result; and
sending at least a portion of the set of second screen results to a fourth screener when the evaluation result reflects an inaccurate second screen result.

20. The method of claim 19, wherein the third screener is one of a group of reviewers and the fourth screener is the same one of the group of reviewers.

21. The method of claim 18, wherein screening at least a portion of the second screen result further comprises:
providing the third screener with a research tool;
evaluating, using the research tool, each of the set of second screen results for which the second screen result represents a suspect condition;
generating an evaluation result from the evaluating step, the evaluation result reflecting either a determination condition or a no determination condition; and
sending at least a portion of the set of second screen results to a fourth screener when the evaluation result reflects a no determination condition.

22. The method of claim 21, wherein the third screener is one of a hierarchy of reviewers and the fourth screener is another of the hierarchy of reviewers.

23. The method of claim 18, further comprising updating at least one of the suspect transaction dataset or the suspect list based at least in part on the third screen result.

24. The method of claim 18, further comprising sending, to a report generator, screen result data reflecting at least the third screen result.

25. The method of claim 24, further comprising generating a report based at least in part on the screen result data.

26. The method of claim 18, wherein the second computer is the first computer.

27. A system for screening a transaction dataset against a master suspect list and removing false positives, the system comprising:
a first screening system comprising a first screener, a first set of screening criteria, and a first data store, and configured to:
generate a suspect transaction dataset by screening the transaction dataset against the master suspect list using the first screener and the first set of screening criteria, and
store the suspect transaction dataset to the first data store;
a second screening system, communicatively coupled with the first screening system, comprising a second screener, a second set of screening criteria, and a second data store, and configured to:
screen at least a portion of the suspect transaction dataset using the second screener and the second set of screening criteria,
generate a second screen result, and
store the second screen result to the second data store;
a third screening system, communicatively coupled with the second screening system, comprising a third screener and a third set of screening criteria, and configured to:
screen at least a portion of the second screen result using the third screener and the third set of screening criteria,
generate a third screen result, and
update the first set of screening criteria based at least in part on the third screen result.

28. The system of claim 27, further comprising a report generator configured to generate a report based at least in part on screen result data, the screen result data reflecting at least the third screen result.

29. The system of claim 27, wherein at least one of the first screening system, the second screening system, or the third screening system comprises a person.
